(19) United States
(12) Patent Application Publication
(10) Pub. No.: US 2021/0090752 A1
(43) Pub. Date: Mar. 25, 2021

(54) Low Energy Nuclear Reactor

(71) Applicants: Pearl Rayms-Keller, Fredericksburg, VA (US); Michael S. Lowry, Fredericksburg, VA (US); Stacy R. Barker, King George, VA (US)

(72) Inventors: Pearl Rayms-Keller, Fredericksburg, VA (US); Michael S. Lowry, Fredericksburg, VA (US); Stacy R. Barker, King George, VA (US)

(73) Assignee: United States of America, as represented by the Secretary of the Navy, Arlington, VA (US)

(21) Appl. No.: 16/579,930

(22) Filed: Sep. 24, 2019

(51) Int. Cl. G21B 3/00

(52) U.S. Cl. CPC G21B 3/002

(57) ABSTRACT

A low energy nuclear reactor (LENR) is provided for producing thermal energy. The LENR includes first and second vessels and an ignitor. The first vessel defined a first chamber containing LENR fuel. The second vessel disposed inside the first vessel defines a second chamber containing exothermic material. The ignitor initiates the exothermic material by sparking. The LENR fuel reacts to produce the thermal energy in response to initiation heat from the exothermic material.

### STATEMENT OF GOVERNMENT INTEREST

The invention described was made in the performance of official duties by one or more employees of the Department of the Navy, and thus, the invention herein may be manufactured, used or licensed by or for the Government of the United States of America for governmental purposes without the payment of any royalties thereon or therefor.

### BACKGROUND

The invention relates generally to heat transfer systems. In particular, the invention relates to a low energy nuclear thermoelectric system for using heat to generate work.

The phenomenon of low energy nuclear reactions (LENR) refers to the occurrence where anomalous quantities of heat are produced when particular metals, e.g., nickel (Ni), palladium (Pd), absorb hydrogen (H) or deuterium (D, hydrogen's next heavier isotope), together with application of an external stimulus such as heat or an electric current. LENR was labeled “cold fusion” in 1989 when originally introduced, amid controversy regarding empirical repeatability and incomplete theoretical support.

LENR has also been labeled “Chemically Assisted Nuclear Reactions” (CANR), “Lattice Assisted Nuclear Reactions” (LANR), “Condensed Matter Nuclear Science” (CMNS), as well as other terms. Such reactions occur at relatively low temperature, and sometimes results in trans-mutation of elements as well as the production of heat. Either no strong radiation is produced, or it is absorbed locally. The waste products are not radioactive.

LENR has attracted attention for its promise of providing safe and inexpensive ways to produce clean energy for many military and commercial applications. LENR involves interactions between hydrogen and deuterium atoms in a metal matrix, usually palladium or nickel, and exhibits steady evolution of heat. In the physics of LENR, hydrogen and deuterium atoms diffuse into vacancies in palladium or nickel or other hydrogen absorbing metal lattices, and reactions between deuterium or hydrogen atoms in these vacancies produce thermal energy. The exact nature of these reactions remains to be elucidated.

Two configurations of experimental apparatus have been used in LENR experiments, a liquid cell, and a solid-state reactor. The oldest system, which is the liquid cell type, is an electrolytic cell in which the cathode is made of a platinum wire or foil. The electrolytic solution is composed of dissolved salts of palladium and lithium.

The second type of apparatus consisting of a vessel containing palladium, nickel or any other metal that can absorb hydrogen ions in a powder, wire, foil, or mesh configurations is exposed to ionic hydrogen or deuterium. Many variations on the configurations of these liquid and solid reactors have been introduced and studied, and many observations of excess heat production, which cannot be explained by conventional chemistry, have been reported. Although the exact nature of LENR remains unknown, the volume of experimental results argues in favor of the validity of the phenomenon of LENR.

### SUMMARY

Generally, all LENR reactors and cells require a fair amount of energy in the form of an electric current—both in electrolytic cells through the electrodes, and as a current through a resistor wire for the solid-state reactors—to be injected into the system in order to initiate the metal and hydrogen to react. In addition, known devices and systems require some thermal control in order to keep the LENR reaction going and to avoid a run-away reaction. This thermal control and management have been achieved by controlling the amount of input energy and/or by removing heat from the system (either via cooling, thermoelectric, or mechanical (e.g., sterling machines) systems.

Exemplary embodiments described herein include novel methods and apparatuses that initiate and modulate LENR reactions to generate excess usable energy. Disclosed is a device to initiate and maintain low energy nuclear reactions and other chemical reactions, and to harvest the net energy produced. The harvested heat energy can be used to activate heat engines or can be transformed in other forms of usable energy. The harvested energy can be exploited to propel and/or activate many electro-mechanical devices of military and commercial importance. Some examples of devices that can be propelled, moved, activated, or energized by these embodiments may include, but no limited to: underwater vehicles, surface vehicles, air vehicles, space vehicles, electronic devices, electric devices, heat engines, thermoelectric systems, steam systems, etc.

According to an aspect of these embodiments, a low energy nuclear reactor includes a first vessel having a first external wall defining a first chamber and a second vessel having a second external wall defining a second chamber. The first vessel is located in the second chamber inside the second vessel. The first chamber contains LENR (low energy nuclear reaction) fuel and the second chamber contains a volume of exothermic ignition material around the first vessel. An ignitor device connects to the exothermic ignition material. The ignitor device may be an electromagnetic device or a mechanical device such a percussion device to trigger a fulminant, e.g., sodium (Na) or copper(II) azides (Cu(N₃)₂). The ignitor device provides a burst of energy to the exothermic ignition material to start an exothermic reaction that delivers heat to the LENR fuel across the first external wall of the first vessel. According to an exemplary device herein, a volume of LENR (low energy nuclear reaction) fuel is disposed in a first chamber.

A volume of exothermic ignition material is disposed in a second chamber. An electromagnetic ignitor connects to the exothermic ignition material. A barrier separates the volume of LENR fuel from the volume of exothermic ignition material. According to the exemplary device herein, the first chamber may be inside the second chamber or the second chamber may be inside the first chamber. The electromagnetic ignitor starts an exothermic reaction in the exothermic ignition material that delivers heat to the LENR fuel across the barrier and initiates an exothermic reaction in the LENR fuel. An exemplary method herein provides a first chamber containing a quantity of LENR (low energy nuclear reaction) fuel, as well as a second chamber containing a quantity of exothermic ignition material. Either the first chamber inserts into the second chamber, or else the second chamber inserts into the first chamber. An electromagnetic burst is used to ignite the exothermic ignition material. The exothermic ignition material delivers heat to the LENR fuel and initiates an exothermic reaction in the LENR fuel. Regardless of the exact nature of the reaction, exemplary embodiments provide ‘excess’ energy that can be harnessed to generate work.

Conventional reactors yield disadvantages addressed by various exemplary embodiments of the present invention. In particular, various exemplary embodiments provide a low energy nuclear reactor (LENR) for producing thermal energy. The LENR includes first and second vessels and an ignitor. The first vessel defined a first chamber containing LENR fuel. The second vessel disposed inside the first vessel defines a second chamber containing exothermic material. The ignitor initiates the exothermic material by sparking. The LENR fuel reacts to produce the thermal energy in response to initiation heat from the exothermic material.

### BRIEF DESCRIPTION OF THE DRAWINGS

These and various other features and aspects of various exemplary embodiments will be readily understood with reference to the following detailed description taken in conjunction with the accompanying drawings, in which like or similar numbers are used throughout, and in which:

FIG. 1 is a set of plan and isometric views of an exemplary container for a low energy nuclear reactor device; and

FIG. 2 is an isometric view of instrumentation and control components for the low energy nuclear reactor device.

### DETAILED DESCRIPTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

This disclosure relates to a device for the generation and management of thermal or electromagnetic energy and the transfer of excess heat from one medium to another. Exemplary embodiments generally cover three main aspects:

1) a formulation and architecture of initiation (i.e., ignition) and LENR fuels, along with a method and device to initiate a chemical and/or low energy nuclear reaction,

2) a method and device that enables the reaction and generation of energy to continue and be modulated, and

3) a system for the transfer of energy from one medium to another medium.

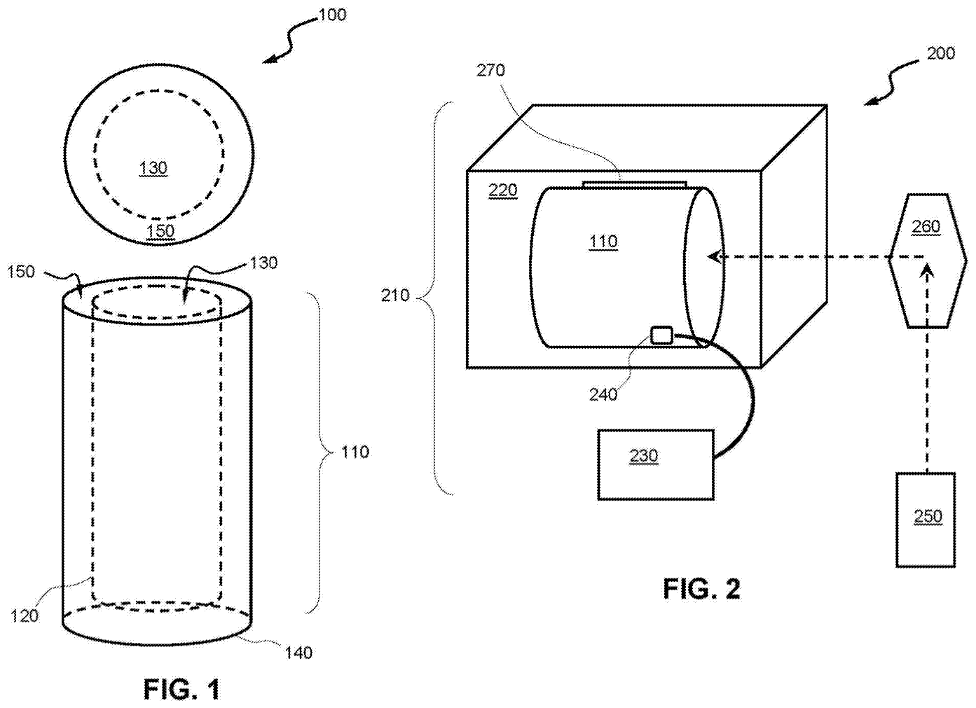

FIG. 1 shows plan and isometric views 100 of a reactor 110 for a LENR device. The reactor 110 includes a first vessel 120 having a first external that defines a first chamber 130. The reactor 110 further includes a second vessel 140 having a second external wall that defines a second chamber 150. As shown, the first vessel 120 inserts into the second chamber 150 within the second vessel 140.

Both the first and second vessels can be composed of a refractory material having high-temperature-resistance and a high melting point. Such materials may include, but not limited to metals, such as: titanium (Ti), tantalum (Ta), tungsten (W), etc. Alternatively, such materials may be composed of alloys, such as Hastelloy, Inconel, and stainless steel, etc., or else ceramics, such as alumina (Al₂O₃) and hafnium boride (HfB₂).

In some embodiments, the first (inner) vessel 120 is filled with LENR fuel and the second (outer) vessel 140 is filled with ignition fuel. Alternatively, the first (inner) vessel 120 is filled with ignition fuel and the second (outer) vessel 140 is filled with LENR fuel. The composition of the LENR fuel and the ignition fuel is described in greater detail below. Both the first vessel 120 and the second vessel 140 may be sealed. In some embodiments, such sealing can be accomplished by a high-temperature cement.

FIG. 2 shows an isometric view 200 of an apparatus assembly 210 that contains the reactor 110 within a housing 220. An electrical power supply 230 conductively connects to an ignitor 240 disposed within ignition fuel in the reactor 110. The housing 220 can be a ceramic box for example. The power supply 230 can be supply direct current (DC) as from a capacitor or battery for sudden bursts of charge to spark the ignition fuel. The ignitor 240 can be a mechanical device, such as a percussion cup to trigger a fulminant for initiating an exothermic reaction.

Examples of fulminant include sodium azide (NaN₃) and copper azide (Cu(N₃)₂). The assembly 210 can be triggered and monitored remotely, such as by a line-of-sight laser thermometer 250 coupled with a mirror 260 to reflect optical signals, as recognized by artisans of ordinary skill. A thermoelectric strip 270 of includes material that converts thermal energy to electric potential, such as by the Seebeck effect to produce electric current. Alternatively, thermal energy can be used to drive a heat exchanger or turbine.

According to exemplary devices and methods herein, the LENR fuel may be made of a mixture of reagents containing lithium (Li) and lithium aluminum hydride (LiAH₄ or “LAH”). In addition, a catalyst, such as nickel (Ni), may be included with the LENR fuel. The nickel may be in powder form and treated to increase its porosity, for example by heating the nickel powder to appropriate temperatures and for times selected to superheat any water (H₂O) present in micro-cavities that are inherently in each particle of nickel powder.

The powder in the fuel mixture consists largely of spherical particles having diameters in the nanometer (nm) to micrometer range (μm), for example between 1 nm and 100 μm. Variations in the ratio of reactants and catalyst tend to govern reaction rate of the LENR fuel and are not critical. However, a suitable mixture can include a starting mixture of approximately 50% nickel, approximately 20% lithium, and approximately 30% LAH. Within this mixture, nickel acts as a catalyst for the reaction, and is not itself a reagent. While nickel is particularly useful because of its relative abundance, its function can also be accomplished by other elements in IUPAC group-10 transition metals of the periodic table, such as platinum (Pt) or palladium (Pa). The ignition fuel may be composed of a mixture containing aluminum (Al) and iron oxide (Fe₂O₃).

Both the ignition fuel and LENR fuel can be in many states, liquid solid, or gas at the beginning, during, or at the end of the reaction. In some embodiments, both the LENR fuel and ignition fuel are designed to have a specific architecture or structure (at the nanometer or above scale) to facilitate and enhance the fuel properties, and/or to make them easier to modulate. Structured fuels can be produced by a variety of techniques, such as electro-spraying, molecular beam epitaxial deposition, micro milling, ion beam milling etc. In some embodiments, a sophisticated, architecturally structured fuel core, may be built by the use of three-dimensional (3D) printing.

The most used hydrogen donor components of the solid state LENR reactor 110 is, or has been, lithium aluminate hydride (LAH). Other hydrogen donor substances that can be exploited as hydrogen in LENR include but are not limited to lithium borohydrate (LiBH₄), sodium alanate (NaAlH₄), di-calcium alanate (Ca(AlH₄)₂), magnesium alanate (Mg(AlH₄)₂) and calcium borohydrate (Ca(BH₄)₂). In some cases, ammonia borane (BH₃NH₃) complex can be used in combination with nickel (Ni) or palladium (Pa), and/or rhodium (Rh) as the LENR fuel. In contrast to LAH in relation to hydrogen-per-mole production 10.5 wt. %, ammonia borane complex is not hazardous, and generates more hydrogen-per-mole at 19.6 wt. %.

Lithium aluminum hydride contains approximately 10.6 wt. % hydrogen, and, upon heating, the hydrogen is desorbed in a three-step decomposition reaction. The decomposition reactions of LAH upon heating are as follows:

3LiAlH₄→Li₃AlH₆+2Al+3H₂ (5.3 wt. % H₂)(150-175° C.) (1)

2Li₃AlH₆→6LiH+2Al+3H₂(2.6 wt. % H₂)(180-220° C.) (2)

2LiH+2Al→2LiAl+H₂ (2.6 wt. % H₂)(>400° C.) (3)

Above approximately 400° C., the reaction is practically irreversible and involves a state in which the liquid aluminum and lithium, and the gaseous hydrogen (H₂), are embedded in a matrix of nickel solid particles.

The overall enthalpy for the reaction inside the reactor 110 remains speculative, but decomposition of lithium aluminum hydrate (also known as lithium alanate) in the presence of a mixture of hydrochloric acid (HCl) and water (H₂O) is about 694 kelvin-joules/mol (K-J/mol). The method for initiating and modulating the LENR reaction consists of exploiting the energy released by an exothermic chemical reaction contained in one vessel to initiate the LENR fuel contained in a second vessel. Both vessels would be in close proximity to each other to facility transfer of energy between them.

As noted above, the ignition fuel may be made of a mixture of aluminum (Al) and iron oxide (Fe₂O₃). The exothermic reaction of iron (Fe) and aluminum (Al) with oxygen (O) can be used as an initiating reaction for the reactor 110. The oxidation reactions of iron (Fe) with oxygen (O) are as follows:

2Fe+O₂→2FeO+Heat

4FeO+O₂→2Fe₂O₃+Heat

A complete reaction between the iron (Fe) and oxidizer is the following:

4Fe(s)+3O₂(g)→2Fe₂O₃(s)+Heat

Aluminum (Al) can be added after the oxidation of the iron (Fe) mixtures to improve the exothermic capability of these reactions:

4Fe(s)+3O₂(g)→+2Fe₂O₃(s)

2Al(s)+Fe₂O₃(s)→2Fe(s)+A₂O₃(s)

The reaction is controlled by adjusting the air flow going to the reactor 110 in such a manner so as to enable sufficient time for oxidation reaction to ignite and self-propagate over the reacting period. The introduction of air into the system is kept at low air flow rate to minimize the convection heat transfer effects, which could dissipate the maximum amount of heat retained inside the reactor 110.

Once the LENR reaction is initiated, the temperature of the LENR reaction can be modulated to avoid a “run-away” reaction by transferring some energy (heat), mostly by diffusion, from the LENR reaction vessel back to the (ignition reaction vessel). The energy absorbed by the spent chemical mixture present in the ignition vessel can then be withdraw from the two-vessel apparatus to generate useful energy or work. Possible mechanisms to withdraw the excess energy may include an appropriate heat exchanger using a “cooling” fluid system such as in a steam generator. Other methods may use thermoelectric materials, e.g., strip 270, and Sterling-machine schemes.

The transfer of energy from one medium to other medium can occur by convection, radiation, conduction, or a combination thereof. As long as the rate of energy loss is equal to the rate of energy production by the LENR process, the temperature will remain stable. Several configurations for the reactor 140 can be used, and one possible approach is shown in view 100 with cylindrical vessels, although alternative shapes are possible, including shapes resembling biological systems, such as the alveoli sacs of the lungs. The choice of vessel shape is a dictated by the energetic nature of the ignition and/or LENR fuels, and by the choice of the vessel material.

Because both the ignition reaction and the LENR reaction are quite exothermic, generating temperature in excess of 1200° C., the vessel material should have a high melting point. For example, silicon nitride (Si₃N₄) can be used as the reactor material due to its high melting temperature of about 2660K. Also, silicon nitride is generally manufactured as a porous material with approximately 40% porosity. In addition to having a melting point higher than 1200° C., the vessel 120 or 140 containing the LENR fuel should also:

1) be gas tight,

2) not be able to absorb or adsorb hydrogen,

3) have high thermal conductivity, and

4) be chemically non-reactive.

The method process can be described as follows:

1) provide a first chamber containing LENR fuel,

2) provide a second chamber containing exothermic ignition material,

3) dispose the first chamber into the second,

4) ignite the exothermic ignition material,

5) collect heat generated from LENR chamber via heat exchanger, and

6) convert gathered heat into usable energy, e.g., electric or mechanical. For the first operation, the first chamber 120 may be filled with nickel or palladium powder that has been mixed with lithium aluminum hydride or ammonia-borane complex, or any chemical capable of evolving hydrogen, e.g., lithium borohydrate (LiBH₄). LAH and ammonia-borane complex are highly hydroscopic. Thus, they should be manipulated under an inert atmosphere, and so this operation should be carried out inside a glove-box filled with inert gas, such as Argon (Ar).

For the second operation, the second chamber 140 contains the ignition formulation, which could be selected methyl isocyanate (C₂H₃NO or MIC) formulations, or any exothermic chemical formulation, e.g., potassium permanganate (KMnO₄) plus glycerin (C₃H₈O₃). For the third operation, the first chamber 120 is disposed inside the second chamber 140. Alternatively, the second chamber 140 is disposed inside the first chamber 120. In one configuration, the LENR fuel occupies the inner (first) vessel 120 while the ignition fuel fills the outer (second) vessel 140. In another configuration, the ignition fuel occupies the inner vessel 120 while the LENR fuel fills the outer vessel 140.

In the fourth operation, the exothermic ignition material 240 is ignited, such as by using an electromagnetic burst or a percussion device to trigger a fulminant. For example, the “ignition” formulation reaction may be initiated by a short burst of electrical energy (e.g., sparks) from an electromagnetic device, e.g., capacitor or battery, serving as an electrical source 230. Alternatively, a fulminant, e.g., sodium or copper azides, can be used to ignite the ignition material. The exothermic ignition material 240 delivers heat to the LENR fuel and initiates an exothermic reaction in the LENR fuel. In the fifth operation, the heat generated by the exothermic reaction in the LENR fuel is collected using an appropriate heat exchanger. For example, a “cooling” fluid system such as in a steam generator can be used to collect the heat generated from the LENR chamber, which can be transformed into useable electrical or mechanical energy in the sixth operation.

The disclosed invention can be used to generate power for aerial, terrestrial, space, and water, and underwater vehicles. In addition, the invention can be used to generate power for housing and storing areas, as well as to provide power for electronic devices of all kinds. Some of the exemplary advantages include a novel ignition (chemical/thermal) system for LENR using exothermic chemical reactions, a novel scheme or method for modulating operation of LENR, using 3-D printing to create more efficient matrix for LENR and/or ignition fuels, and using ammona borane complex as a hydrogen source for the LENR reactor.

Artisans of ordinary skill will recognize that, in the light of the above teachings, specifics described herein are subject to modification without departing from the claims recited herein. Any numerical parameters set forth herein are approximations (for example, by using the term “about” or “approximately”) that may vary depending upon the desired properties sought to be obtained by exemplary embodiments. At the very least, and not as an attempt to limit the application of the doctrine of equivalents to the scope of the claims, each numerical parameter should at least be construed in light of the number of significant digits and by applying ordinary rounding.

While certain features of the embodiments of the invention have been illustrated as described herein, many modifications, substitutions, changes and equivalents will now occur to those skilled in the art. It is, therefore, to be understood that the appended claims are intended to cover all such modifications and changes as fall within the true spirit of the embodiments.

What is claimed is:

1. A low energy nuclear reactor (LENR) for providing thermal energy, said LENR comprising:
a first vessel defining a first chamber containing LENR fuel;
a second vessel disposed inside said first vessel and defining a second chamber containing exothermic material; and
an ignitor for initiating said exothermic material by sparking, wherein said LENR fuel reacts to produce the thermal energy in response to initiation heat from said exothermic material.

2. The LENR according to claim 1, further comprising an electric source to provide said sparking as sudden energy application.

3. The LENR according to claim 1, wherein said LENR fuel comprises lithium (Li) and lithium aluminum hydride (LiAlH₄) as reagents and nickel (Ni) as a catalyst.

4. The LENR according to claim 1, wherein said exothermic material comprises aluminum (Al) and iron oxide (Fe₂O₃).

5. The LENR according to claim 1, further comprising a Seebeck device to convert said thermal energy into electrical energy.

6. The LENR according to claim 1, wherein said vessels are composed of at least one of titanium (Ti), tantalum (Ta), tungsten (W), Hastelloy, Inconel, stainless steel, alumina (Al₂O₃), and hafnium boride (HfB₂).

7. The LENR according to claim 1, wherein said ignitor is composed of one of sodium azide (NaN₃) and copper azide (Cu(N₃)₂).
